(19) United States
(12) Patent Application Publication
(10) Pub. No.: US 2007/0002178 A1
(43) Pub. Date: Jan. 4, 2007

(54) Video display device and video display method

(75) Inventors: Shoji Uehara, Kumagaya-shi (JP); Toshiyasu Tamura, Kumagaya-shi (JP); Hiroshi Kitami, Fukaya-shi (JP); Kenichiro Aso, Higashimatsuyama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/476,778

(22) Filed: Jun. 29, 2006

(30) Foreign Application Priority Data
Jun. 30, 2005 (JP) 2005-193148

(51) Int. Cl. H04N 9/74

(52) U.S. Cl. 348/581

(57) ABSTRACT

According to one embodiment, when an input video signal is of a form which can be satisfied by performing only a horizontal scaling process, a selector is controlled to directly supply the input video signal to a horizontal scaling process section. When the input video signal is of a form which requires vertical and horizontal scaling processes, the selector is controlled such that a video signal output from a preceding scaling process section is supplied to the horizontal scaling process section.

### CROSS-REFERENCE TO RELATED APPLICATIONS

This application is based upon and claims the benefit of priority from Japanese Patent Application No. 2005-193148, filed Jun. 30, 2005, the entire contents of which are incorporated herein by reference.

### BACKGROUND

1. Field

One embodiment of the invention relates to improvement in a video display device and a video display method which perform a scaling process to an input video signal.

2. Description of the Related Art

As is well known, in a video display device such as, for example, a television broadcast receiver, a vertical or horizontal scaling process is performed to a video signal to be output depending on an aspect ratio, a resolution, and the like of a display to be used.

In this case, for example, each time the resolution of the display changes, a scaling process circuit which performs a scaling process corresponding to the resolution is inefficient from various points of view and is not suitable for practical use.

In general, an existing scaling process circuit is used with a high regard for economical efficiency to perform a scaling process to a video signal, and a scaling process is performed by using another scaling process circuit to make up the shortage in resolution, so that a necessary resolution is obtained.

However, since a scaling process is performed to a video signal more than once in a type of usage of the scaling process circuit, the video signal is deteriorated to deteriorate image quality.

Jpn. Pat. Appln. KOKAI Publication No. 2003-299037 discloses the following configuration. First and second number-of-pixels processing sections perform an interpolating operation to cause image data supplied to the number-of-pixels processing sections to have the numbers of pixels matched to formats of the respective systems, and generated first and second output data are output together with first and second output synchronous signals.

In Jpn. Pat. Appln. KOKAI Publication No. 2003-299037, however, a system which converts one input signal into signals of a plurality of formats to output the signals has an object to reduce an amount of data of a memory by delaying the input signals in the respective formats, and solution of a problem caused by performing a scaling process to a video signal more than once is not described at all.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 shows an embodiment of the present invention and is a perspective view shown to explain an appearance of a television broadcast receiver;

FIG. 2 is a block diagram shown to explain a signal processing system of the television broadcast receiver according to the embodiment;

FIG. 3 is a block diagram shown to explain details of a scaling process section of the television broadcast receiver according to the embodiment;

FIG. 4 is a flow chart shown to explain a processing operation of the scaling process section according to the embodiment; and

FIG. 5 is a block diagram shown to explain a modification of the scaling process section of the television broadcast receiver according to the embodiment.

### DETAILED DESCRIPTION

Various embodiments according to the invention will be described hereinafter with reference to the accompanying drawings. In general, according to one embodiment of the invention, when an input video signal is of a form which can be satisfied by performing only a horizontal scaling process, a selector is controlled to directly supply the input video signal to a horizontal scaling process section. When the input video signal is of a form which requires vertical and horizontal scaling processes, the selector is controlled such that a video signal output from a preceding scaling process section is supplied to the horizontal scaling process section.

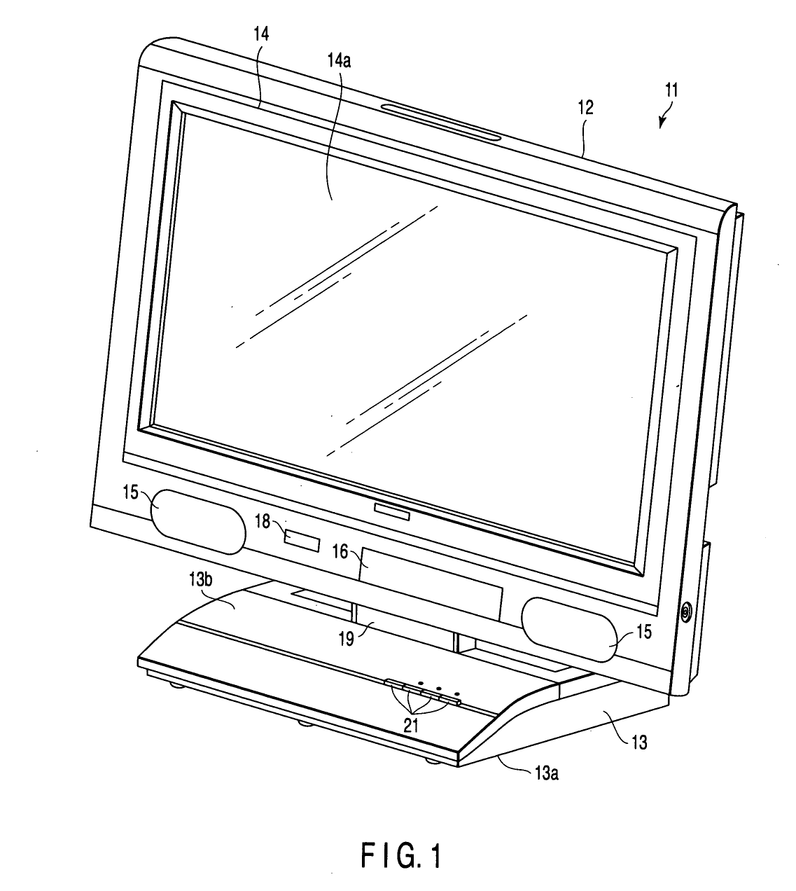

FIG. 1 shows an appearance of a front side of a television broadcast receiver 11 to be explained in the embodiment. More specifically, the television broadcast receiver 11 is constituted by a thin cabinet 12 serving as a device main body and having an almost square shape and a stand 13 which stands and supports the thin cabinet 12.

In the thin cabinet 12, a display screen 14a of the video display unit 14 constituted by, for example, a flat liquid crystal display panel is exposed to the front face of the thin cabinet 12, and a pair of loudspeakers 15, an operation section 16, a light-receiving section 18 to receive operation information transmitted from a remote controller (not shown in FIG. 1) 17, and the like are arranged.

The stand 13 is formed in the form of an almost thin box and designed such that a bottom plate 13a serving as one side of the stand 13 is placed on a predetermined base (not shown) horizontally arranged. The stand 13 is supported in such a state that a support member 19 projecting from an almost central portion of an upper plate 13b serving as a side opposing the side which is placed on the base is connected to a back surface of the cabinet 12 to stand the cabinet 12 up.

In this case, in the stand 13, an HDD unit (not shown in FIG. 1) 20 to be described later is included. On the upper plate 13b of the stand 13, a plurality (four in FIG. 1) of operators 21 which can be operated by pressing to control an HDD unit 20 in a recording state, a reproducing state, a stopping state, or the like are arranged on a portion hanging out of the cabinet 12.

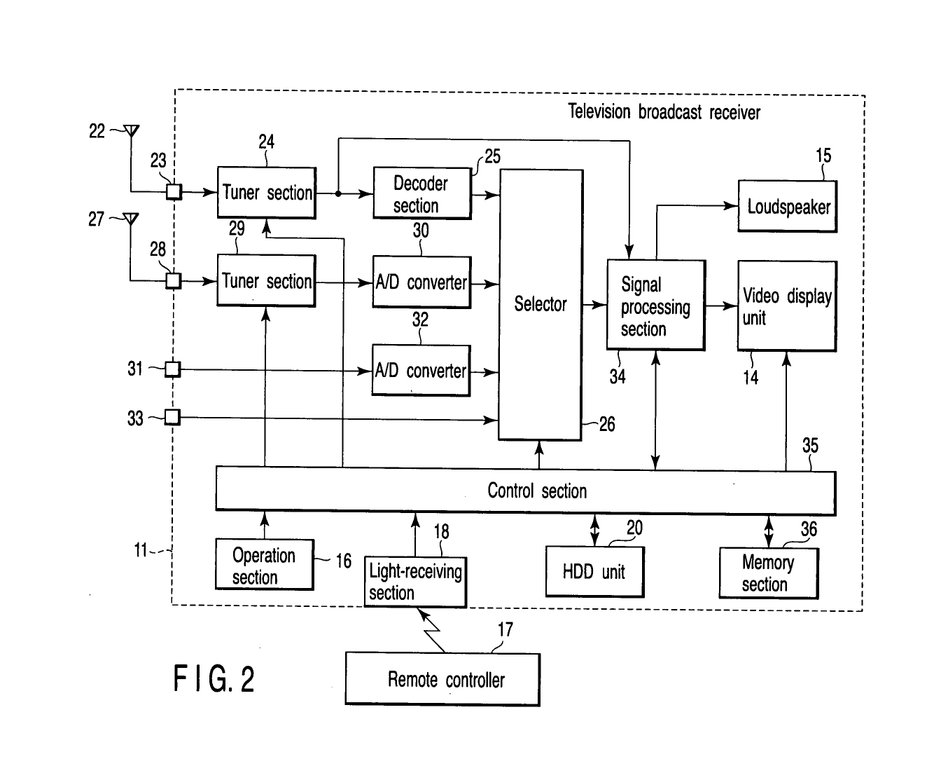

FIG. 2 schematically shows a signal processing system of the television broadcast receiver 11. Various circuit blocks constituting the signal processing system are arranged at a position close to a back surface in the cabinet 12, i.e., around a rear side of the display screen 14a of the video display unit 14.

A digital television broadcast signal received by an antenna 22 for receiving a digital television broadcast signal is supplied to a tuner section 24 through an input terminal 23. The tuner section 24 selects a signal of a desired channel from input digital television broadcasting signals to demodulate the signal. A signal output from the tuner section 24 is supplied to the decoder section 25 and subjected to, for example, an orthogonal frequency division multiplexing (OFDM) decode process, and then supplied to a selector 26.

Furthermore, an analog television broadcast signal received by an antenna 27 for receiving an analog television broadcast signal is supplied to a tuner section 29 through an input terminal 28. The tuner section 29 selects a signal of a desired channel from input analog television broadcast signals to demodulate the signal. A signal output from the tuner section 29 is digitized by an analog/digital (A/D) converter 30 and then output to the selector 26.

Analog video and audio signals supplied to an input terminal 31 for an analog signal is supplied to an A/D converter 32 and digitized, and then output to the selector 26. Furthermore, digital video and audio signals supplied to an input terminal 33 for a digital signal are directly supplied to the selector 26.

The selector 26 selects one of the input video and audio signals of four types to supply the selected signal to a signal processing section 34. The signal processing section 34 performs predetermined signal processing and scaling processing, etc. to the input digital video signal to cause the signal to serve to perform video display on the video display unit 14.

The video signal output from the tuner section 24 is supplied to the signal processing section 34 to perform a scaling process. Furthermore, the signal processing section 34 also generates an on-screen display (OSD) signal to display a video image on the video display unit 14.

As the video display unit 14, for example, a flat display panel constituted by a liquid crystal display or a plasma display. The signal processing section 34 performs predetermined signal processing to the input digital audio signal to convert the signal into an analog signal and outputs the signal to the loudspeakers 15 to perform audio reproduction.

In this case, in the television broadcast receiver 11, various operations including the various receiving operations are integrally controlled by a control section 35. The control section 35 is a microprocessor in which a central processing unit (CPU) and the like are built. The control section 35 receives operation information from the operation section 16 and the operators 21 (not shown in FIG. 2) or operation information transmitted from the remote controller 17 through the light-receiving section 18 to control the respective sections such that the operation contents are reflected.

In this case, the control section 35 uses a memory section 36. The memory section 36 mainly includes a read only memory (ROM) which stores a control program executed by the CPU, a random access memory (RAM) to provide a work area to the CPU, and a nonvolatile memory in which various setting information, control information, and the like are stored.

In this case, the control section 35 is connected to the HDD unit 20 stored in the stand 13. In this manner, the television broadcast receiver 11 can record digital video and audio signals selected by the selector 26 by using the HDD unit 20. The control section 35 can also reproduce the digital video and audio signals recorded on the HDD unit 20 to cause the signals to be used in an audio-visual service.

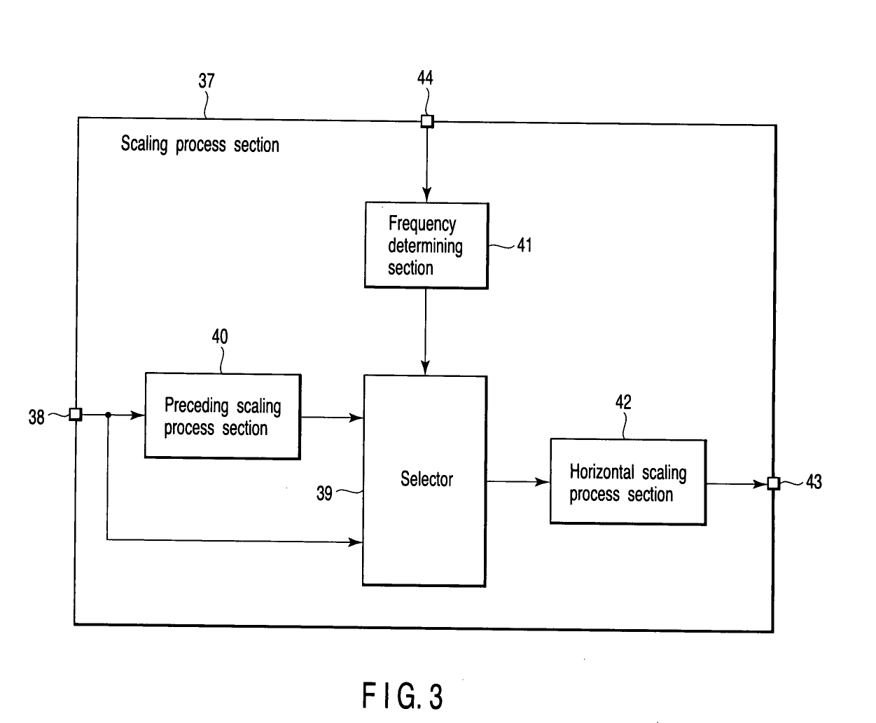

FIG. 3 shows the details of a scaling process section 37 included in the signal processing section 34. More specifically, a video signal supplied to an input terminal 38 is directly supplied to one input terminal of a selector 39, subjected to vertical and horizontal scaling processes by a preceding scaling process section 40, and then supplied to the other input terminal of the selector 39.

The selector 39 selectively derives any input video signal by a select signal output from a frequency determining section 41. The video signal derived from the selector 39 is supplied to a horizontal scaling process section 42, subjected to a horizontal scaling process, and then supplied to the video display unit 14 through an output terminal 43.

In this case, a video signal output from the tuner section 24 is supplied to the frequency determining section 41 through an input terminal 44. The frequency determining section 41 determines, on the basis of a frequency of the input video signal, whether or not the video signal, i.e., the video signal supplied to the input terminal 38 is of a form in which only the horizontal scaling process may be satisfactorily performed.

When it is determined that the video signal supplied to the input terminal 38 is of a form which can be satisfied by performing only the horizontal scaling process, the frequency determining section 41 outputs a select signal to the selector 39 such that the video signal supplied to the input terminal 38 is directly supplied to the horizontal scaling process section 42.

In this manner, the video signal supplied to the input terminal 38 is subjected to only the horizontal scaling process by the horizontal scaling process section 42 to serve to video display. More specifically, the video signal supplied to the input terminal 38 is prevented from being supplied to the preceding scaling process section 40 and subjected to a vertical scaling process unnecessary for the video signal.

The video signal supplied to the input terminal 38 is subjected to the horizontal scaling process by the horizontal scaling process section 42 only once without being subjected to the horizontal scaling process by the preceding scaling process section 40, so that image quality can be prevented from being deteriorated.

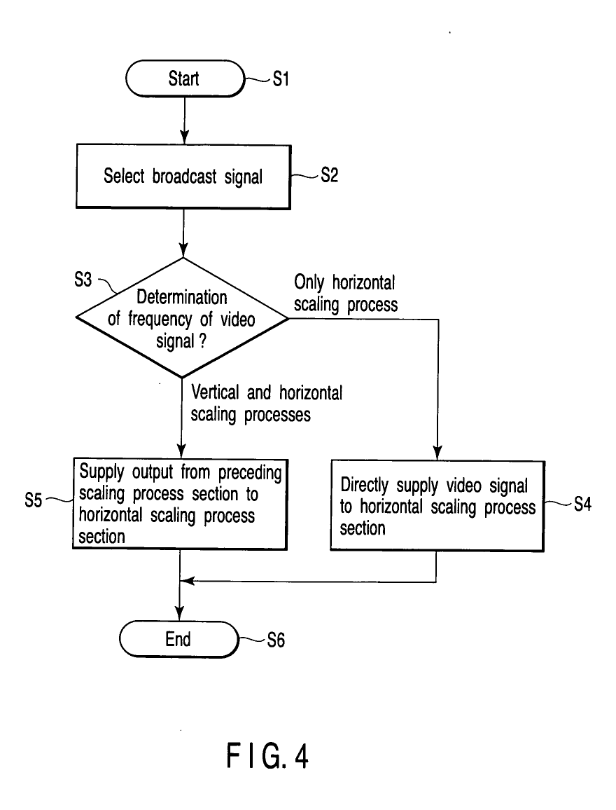

FIG. 4 shows a flow chart showing an entire processing operation of the scaling process section 37. More specifically, when the process is started (block S1), a predetermined digital television broadcast signal is selected by the tuner section 24 in block S2. In this case, the frequency determining section 41 determines a frequency of a video signal supplied to the input terminal 44 in block S3 to determine whether or not the video signal is of a form which can be satisfied by performing only a horizontal scaling process.

When it is determined that the video signal is of the form which can be satisfied by performing only the horizontal scaling process, the frequency determining section 41 controls the selector 39 in block S4 such that the video signal supplied to the input terminal 38 is directly supplied to the horizontal scaling process section 42, and ends the process (block S6).

When it is determined in block S3 that the video signal is of a form which requires vertical and horizontal scaling processes, the frequency determining section 41 controls the selector 39 in block S5 such that the video signal output from the preceding scaling process section 40 is supplied to the horizontal scaling process section 42, and ends the process (block S6).

According to the embodiment, when an input video signal is of a form which can be satisfied by performing only a horizontal scaling process, the input video signal is directly supplied to the horizontal scaling process section 42 to be subjected to only the horizontal scaling process. For this reason, the scaling process can be performed a minimum necessary number of times depending on the form of the input video signal, and a practical scaling process can be realized while preventing the image quality from being deteriorated.

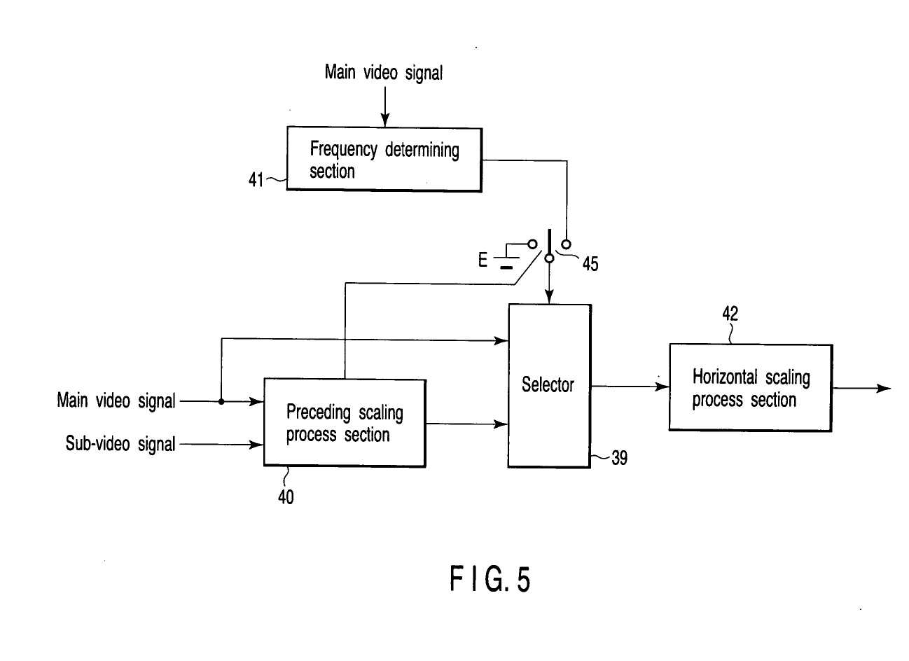

FIG. 5 shows a modification of the above-described embodiment. The modification will be explained below such that the same reference numerals as in FIG. 3 denote the same parts in FIG. 5. The preceding scaling process section 40 has a function that receives a main video signal and a sub-video signal displayed on a multi-screen together with the main video signal and performs vertical and horizontal scaling processes to the main video signal and the sub-video signal in a form of multi-screen display.

When the preceding scaling process section 40 receives only the main video signal without receiving the sub-video signal, the preceding scaling process section 40 switches a switch 45 such that a select signal output from the frequency determining section 41 is supplied to the selector 39.

In this manner, when a main video signal is input as a video signal, as in the above description, a main video signal the form of which can be satisfied by performing only a horizontal scaling process is directly supplied to the horizontal scaling process section 42, and a main video signal the form of which requires vertical and horizontal scaling processes is supplied to the preceding scaling process section 40 and the horizontal scaling process section 42.

On the other hand, both a main video signal and a sub-video signal are supplied to the preceding scaling process section 40, the preceding scaling process section 40 switches the switch 45 such that a signal having a fixed level E is supplied to the selector 39. The level E of the signal supplied to the selector 39 is equal to the level of a select signal which controls the selector 39 such that an output from the preceding scaling process section 40 is guided to the horizontal scaling process section 42.

More specifically, when both a main video signal and a sub-video signal are supplied, an output from the preceding scaling process section 40 is forcibly set such that the output is guided to the horizontal scaling process section 42 regardless of a determination result of the frequency determining section 41. In this manner, a scaling process can be performed without damaging the form of a multi-screen display of a main video signal and a sub-video signal.

The main video signal and the sub-video signal are explained as video signals in FIG. 5. However, even though a plurality of video signals of a form which performs video display by simultaneous display are input, it is effective that an output from the preceding scaling process section 40 is forcibly set to be guided to the horizontal scaling process section 42.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video display device comprising:
an input section configured to receive a video signal;
a first scaling process section configured to perform vertical and horizontal scaling processes to the video signal input to the input section;
a selecting section configured to selectively derive the video signal input to the input section and a video signal output from the first scaling process section;
a second scaling process section configured to perform a horizontal scaling process to the video signal derived by the selecting section; and
a control section configured to determine whether or not the video signal input to the input section is of a form which can be satisfied by performing only the horizontal scaling process and to control the selecting section on the basis of the determination result.

2. A video display device according to claim 1, wherein
the control section comprises:
a determining section configured to determine whether or not the video signal input to the input section is of a form which can be satisfied by performing only the horizontal scaling process; and
a selection control section configured to control the selecting section such that the video signal input to the input section is supplied to the second scaling process section when the determining section determines that the video signal input to the input section is of the form which can be satisfied by performing only the horizontal scaling process and to control the selecting section such that the video signal output from the first scaling process section is supplied to the second scaling process section when the determining section determines that the video signal input to the input section is of a form which requires the vertical and horizontal scaling processes.

3. A video display device according to claim 2, wherein
the determining section is configured to determine, on the basis of a frequency of the video signal input to the input section, whether or not the video signal input to the input section is of the form which can be satisfied by performing only the horizontal scaling process.

4. A video display device according to claim 2, further comprising:
a forcible control section configured to forcibly control the selecting section such that, when the video signal input to the input section includes a plurality of video signals of a form of simultaneous display, the video signal output from the first scaling process section is supplied to the second scaling process section regardless of a determination result of the determining section.

5. A video display device according to claim 4, wherein
said plurality of video signals include a main video signal and a sub-video signal which is displayed on a multi-screen together with the main video signal.

6. A video display method comprising:
a first block of inputting a video signal;
a second block of causing the first scaling process section to perform vertical and horizontal scaling processes to the video signal input in the first block;
a third block of selectively deriving the video signal input in the first block and a video signal output from the first scaling process section in the second block;
a fourth block of causing the second scaling process section to perform a horizontal scaling process to the video signal derived by the selecting section in the third block; and
a fifth block of determining whether or not the video signal input in the first block is of a form which can be satisfied by performing only the horizontal scaling process and controlling the selecting section on the basis of the determination result.

7. A video display method according to claim 6, wherein
the fifth block comprises:
a determining block of determining whether or not the video signal input in the first block is of a form which can be satisfied by performing only the horizontal scaling process; and
a selection control block of controlling the selecting section such that the video signal input in the first block is supplied to the second scaling process section when the determining section determines that the video signal input in the first block is of the form which can be satisfied by performing only the horizontal scaling process and controlling the selecting section such that the video signal output from the first scaling process section is supplied to the second scaling process section when the determining section determines that the video signal input in the first block is of a form which requires the vertical and horizontal scaling processes.

8. A video display method according to claim 7, wherein
in the determining block, it is determined, on the basis of a frequency of the video signal input in the first block, whether or not the video signal input in the first block is of the form which can be satisfied by performing only the horizontal scaling process.

9. A video display method according to claim 7, further comprising:
a forcible control block of forcibly controlling the selecting section such that, when the video signal input in the first block includes a plurality of video signals of a form of simultaneous display, the video signal output from the first scaling process section is supplied to the second scaling process section regardless of a determination result in the determining block.

10. A video display device according to claim 9, wherein
said plurality of video signals include a main video signal and a sub-video signal which is displayed on a multi-screen together with the main video signal.
